(19) United States
(12) Patent Application Publication
(10) Pub. No.: US 2022/0313391 A1
(43) Pub. Date: Oct. 6, 2022

(54) METHODS AND APPARATUSES FOR ORTHODONTIC ALIGNERS WITH PRESSURE AREAS

(71) Applicant: Larry J. Moray, Chapel Hill, NC (US)

(72) Inventor: Larry J. Moray, Chapel Hill, NC (US)

(21) Appl. No.: 17/484,651

(22) Filed: Sep. 24, 2021

Related U.S. Application Data
(60) Provisional application No. 63/168,609, filed on Mar. 31, 2021.

(51) Int. Cl. A61C 7/00; A61C 7/08

(52) U.S. Cl. CPC A61C 7/002; A61C 7/08

(57) ABSTRACT

Methods and apparatuses for orthodontic aligners with specific inwardly extruding pressure areas that work alone or in combination with other inwardly extruding pressure areas to provide a particular force or movement to one or more teeth are disclosed. The inwardly extruding pressure areas in the orthodontic aligners are created by digitally removing a portion of a tooth in a three-dimensional model of the tooth and then creating a model using the modified three-dimensional model. Orthodontic aligners are then thermoformed over the modified three-dimensional model, which causes the aligner material to fill in the removed portions of the teeth such that where the aligners fill those gaps, inwardly extruding pressure areas are created, since the patient's actual teeth do not have any such portion removed.

### CROSS-REFERENCE TO RELATED APPLICATIONS

This application claims priority to U.S. Provisional Patent Application No. 63/168,609 filed on Mar. 31, 2021, by Larry J. Moray, entitled “METHODS AND APPARATUSES FOR ORTHODONTIC ALIGNERS WITH PRESSURE AREAS,” the entire contents of which are incorporated by reference herein.

### TECHNICAL FIELD

The present invention is related generally to the field of orthodontics. More particularly, the present invention is related to improved orthodontic aligners that provide specific movement forces to the teeth using pressure areas.

### BACKGROUND

Orthodontic treatments involve repositioning misaligned teeth and improving bite configurations for improved cosmetic appearance and dental function. The repositioning of the misaligned teeth is accomplished by applying controlled forces to the teeth over an extended period of time.

Orthodontic aligners (also referred to as dental aligners) are a well-known way of repositioning misaligned teeth. They provide tooth movement through a series of incremental adjustments to the teeth by wearing a series of the aligners over time.

Orthodontic aligners are made of a thin material that generally conforms to a patient's teeth but are slightly out of alignment with the initial tooth configuration. Placement of the aligners over the teeth applies controlled forces in specific locations to gradually move the teeth into the new configuration. Repetition of this process with successive aligners that provide slightly modified configurations eventually moves the teeth through a series of intermediate configuration to a final desired configuration.

Traditional aligners depend on the physical features and configuration of the patient's teeth, among other factors. As a result of relying on the natural fit with the teeth being moved, traditional orthodontic aligners have difficulty applying certain forces to individual teeth. For example, traditional aligners have difficulty applying extrusive forces, which are forces that pull a tooth away from the jaw. Similarly, traditional aligners have difficulty applying rotational forces to a single tooth because there may not be enough contact area between the tooth to be rotated and the aligners at the points where the contact needs to occur in order to cause the tooth to rotate.

One solution to this problem has been to use attachments on the teeth that engage the orthodontic aligners. The attachments are bonded to one or more teeth at specific locations, and they help the aligners to engage the teeth. The attachments may be various shapes chosen to apply a particular force to the tooth.

Attachments, however, have their own problems. For example, placing the attachments on a patient's teeth is a difficult, time-consuming, and technique-sensitive process for orthodontists and their staff. Once placed, attachments can fall off relatively easily, break, chip, and generally can be a hassle. Additionally, they are often less aesthetically pleasing, and they can be annoying to the patient.

It would be beneficial to have orthodontic aligners that can apply specific forces that cause particular movements of the teeth where traditional orthodontic aligners do not work well.

### SUMMARY

Accordingly, described herein are methods and apparatuses for orthodontic aligners that use pressure areas to provide specific forces to one or more teeth without the use of attachments.

This summary is provided to introduce in a simplified form concepts that are further described in the following detailed descriptions. This summary is not intended to identify key features or essential features of the claimed subject matter, nor is it to be construed as limiting the scope of the claimed subject matter.

Described herein are methods and apparatuses for orthodontic aligners with specific pressure areas that work alone or in combination with other pressure areas to provide particular force or movement to one or more teeth. The pressure areas in the orthodontic aligners are created by digitally or virtually removing a portion of a tooth in a three-dimensional model of the tooth and then creating a model using the modified three-dimensional model. Orthodontic aligners are then thermoformed over the modified three-dimensional model, which causes the aligner material to fill in the removed portions of the teeth such that where the aligners fill those gaps, pressure areas are created, since the patient's actual teeth do not have any such portion removed.

### BRIEF DESCRIPTION OF THE DRAWINGS

In order to describe the technical solutions of the examples of the present invention more clearly, the figures required to be used for the examples will be briefly introduced below. It should be understood that the following figures only show some examples of the present invention, and thus shall not be construed as limiting the scope thereof; and for a person skilled in the art, further relevant figures could also be obtained according to the figures without using inventive efforts.

FIG. 1A depicts a well-known orthodontic aligner, and the corresponding teeth to which the orthodontic aligner is fitted.

FIG. 1B depicts the corresponding teeth or positive model to which the orthodontic aligner of FIG. 1A is fitted.

FIG. 2A depicts an example of using orthodontic aligners with pressure areas to apply anterior torque to one or more incisors.

FIG. 2B depicts an orthodontic aligner with pressure areas added corresponding to FIG. 2A.

FIG. 3 depicts an example of using orthodontic aligners with pressure areas to apply torque and extrusion forces to premolars and molars.

FIG. 4A depicts an example of using orthodontic aligners with a pressure cap to apply an intrusive force to a tooth.

FIG. 4B depicts an example of using orthodontic aligners with a pressure collar to apply an extrusive force to a tooth.

FIG. 4C depicts an example of using orthodontic aligners with opposing pressure fields to apply a rotational torque to a tooth.

FIG. 5A depicts an example of using orthodontic aligners with a pressure field to apply a hinge torque force to a tooth about a rotational axis of the tooth.

FIG. 5B depicts an example of using orthodontic aligners with opposing pressure fields to apply a pure torque force to a tooth about the long axis of the tooth.

FIG. 6 depicts an example of using orthodontic aligners with one or more pressure fields to apply a bodily translational force to a tooth along the gumline.

FIG. 7 shows an exemplary method for producing an orthodontic aligner for application to teeth of a patient and configured for moving at least one tooth of the patient in accordance with the disclosure herein.

### DETAILED DESCRIPTION OF THE EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

Embodiments of the presently disclosed subject matter provide for improved orthodontic aligners that provide specific forces to a tooth using one or more pressure areas that engage the tooth without the need for tooth attachments.

Disclosed herein is an orthodontic aligner for application to teeth of a patient and configured for moving at least one tooth of the patient. The orthodontic aligner includes a shell portion having an outer surface and an inner surface. At least a portion of the inner surface is configured to contact the teeth of the patient. The inner surface includes at least one extruded pressure area that forms a force-applying component for application of a force to at least one tooth when the orthodontic aligner is engaged with the teeth of the patient. It will be understood that aligners, as used herein, includes clear aligners.

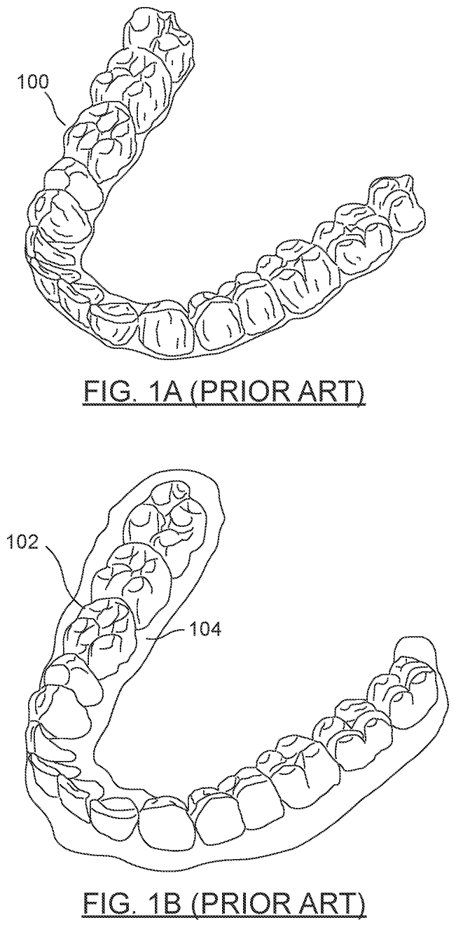

FIGS. 1A and 1B depict a well-known orthodontic aligner 100 and the corresponding teeth 102 or positive model to which the orthodontic aligner is fitted.

FIG. 1A depicts a well-known orthodontic aligner 100. Well-known orthodontic aligners 100 are thermoformed to approximately match a patient's teeth, with slight changes in the aligners that cause incremental movement of the teeth over time.

FIG. 1B depicts the corresponding teeth 102 or positive model to which the orthodontic aligner 100 of FIG. 1A is fitted. Positive models of a patient's teeth represent an approximately exact replica of the state of the patient's teeth at the time the model was created. The positive model of the patient's teeth may be created using various methods, including using an impression kit, using an intraoral scan and then 3D printing the scan, or using photographs and generating a representation of the teeth from the photographs and then 3D printing the representation. FIG. 1B further shows gums 104 (or a representation of gums in the example where a positive model is used).

In orthodontics, torque (e.g., rotational force) may be applied in various different ways. For example, torque may be palatal (i.e., toward the palate), lingual (i.e., toward the tongue), buccal (i.e., into the cheek), labial (i.e., toward the lips), or facial (i.e., toward the face). Each of these types/directions of torque may be applied to the root of the tooth or to the crown of the tooth. When a torque is applied to a tooth, that tooth will rotate according to the size and direction of the torque applied. Depending on the configuration, the tooth may rotate around a center of resistance, a center of rotation, or a point at which the tooth contacts adjacent teeth.

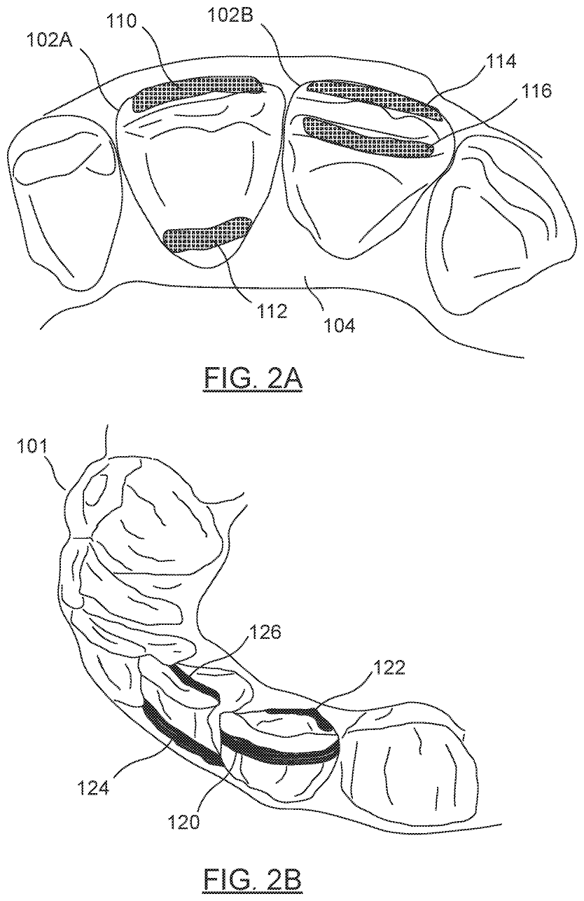

FIG. 2A depicts an example of using orthodontic aligners with pressure areas to apply anterior torque to one or more incisors.

The teeth 102 (shown as 102A and 102B) depicted in FIG. 2A may be either a physical three-dimensional model of the patient's teeth or a digital representation of the patient's teeth. In either case, the principles described herein apply equally to both.

A dentist or orthodontist may identify areas of one or more of the teeth where specific forces, for example, torque, should be applied to the teeth to generate the desired movement and/or rotation of the teeth. In the anterior torque example shown in FIG. 2A, applying forces using pressure areas such as pressure fields on the upper central incisors at the locations shown in FIG. 2A creates a couple that produces a moment that will differentially move the root and/or crown depending on the relative force applied at each pressure field. Resultant moments would upright or procline the crown/root around the tooth's horizontal center of resistance, which, in the example shown in FIG. 2A, is approximately two-thirds of the way up the root of the tooth from the root tip. The amount and direction of movement is dependent on the force and position of the pressure fields.

In other words, the upper central incisor 102A of FIG. 2A has been identified as needing to be torqued inwardly into the patient's mouth (e.g., palatal or lingual crown torque). To accomplish such an inward torque, forces are applied to the bottom of the inside of the tooth near the gingival line as well as to the top of the outside of the tooth using inwardly extruding pressure fields on the inside of the orthodontic aligner. The combination of these two forces applies a palatal or lingual crown torque and causes the tooth to rotate inwardly about an axis approximately where the gum or gingival line 104 is located. Conversely, the upper central incisor 102B has been identified as needing to be rotated outwardly from the patient's mouth (e.g., labial or facial crown torque). To accomplish such an outward torque, forces are applied to the top of the inside of the tooth as well as to the bottom of the outside of the tooth using extruding pressure fields on the inside of the orthodontic aligner. The combination of these two forces applies a labial or facial crown torque and cause the tooth to rotate outwardly about an axis approximately where the gum line 104 is located.

However, as described above, there are certain types of desired forces that cannot be effectively applied to teeth using traditional orthodontic aligners 100 because traditional aligners engage the teeth in such a way as to make it difficult or impossible to apply these specifically desired forces. Each mouth is different, so the specifics of which forces can be applied using traditional orthodontic aligners 100, and which forces cannot, is dependent on the configuration and/or shape of the patient's teeth.

The cross-hatching shown in FIG. 2A shows where on teeth 102A and 102B the pressure fields 120, 122, 124, and 126 are added to orthodontic aligners 101 (shown in FIG. 2B) to cause the desired torque. These pressure fields 120, 122, 124, and 126 may be added to an orthodontic aligner 101 by digitally or virtually removing a small portion of the teeth in the specific areas where the forces are desired. Such areas are shown as 110, 112, 114, and 116 in FIG. 2A. When a three-dimensional model of the modified teeth is created, for example, by 3D printing, those digitally removed portions of the teeth will not be on the model. Thus, when an orthodontic aligner 101 is thermoformed over the modified model, the aligner material fills in the removed areas 110, 112, 114, and 116, thereby creating inward extrusions 120, 122, 124, and 126 in the orthodontic aligner 101 that form a pressure area that will contact the patient's tooth at that location when the orthodontic aligner is worn by the patient. In some embodiments, the pressure fields 120, 122, 124, and 126 may be pressure ridges.

The inward extrusions created may be referred to herein as a pressure area or a pressure field. The pressure area or pressure field may be of various different types or shapes in accordance with the subject matter disclosed herein. For example, a pressure area may be a pressure ridge, a pressure plate, a pressure point, a pressure field, a pressure cap, a pressure collar, or the like, depending on the physical configuration of the pressure area. In various embodiments shown and described herein, the inwardly extruding pressure areas or pressure fields on the orthodontic aligners extrude or extend inwardly approximately 0.2 mm from inner shell of the orthodontic aligner. Currently available orthodontic aligner design software generally limits the depth of extrusions to be greater than 0.9 mm, which is too large to allow the aligner to properly seat in the patient's mouth. In some embodiments, the depth of the inward extrusion begins at an initial value of 0.1 mm, and the size or surface area of the pressure area or pressure field is varied to apply the desired amount of force.

FIG. 2B depicts an orthodontic aligner 101 with pressure areas 120, 122, 124, and 126 added corresponding to FIG. 2A.

As can be seen in FIG. 2B, the thermoformed orthodontic aligner 101 includes inward extrusions 120, 122, 124, and 126 on the inner surface (shown using shading) that correspond to the identified portions 110, 112, 114, and 116 shown in FIG. 2A. For clarity, the inward extrusions 120, 122, 124, and 126 shown in FIG. 2B extrude inwardly into the interior of the orthodontic aligner 101, toward the patient's teeth.

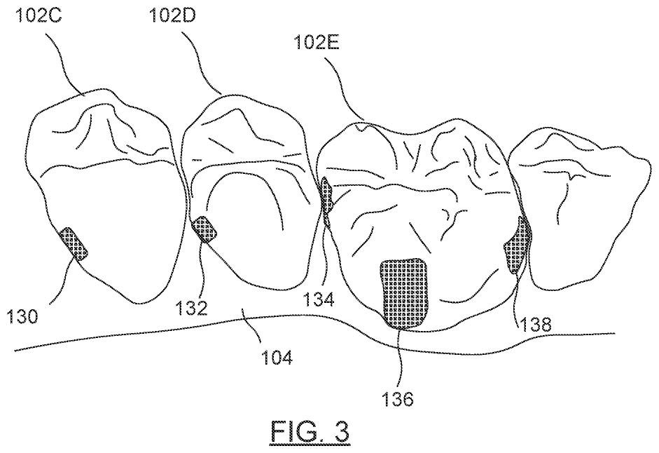

FIG. 3 depicts an example of using orthodontic aligners with pressure areas to apply torque and extrusion forces to premolars and molars.

In the torque and extrusion example shown in FIG. 3, the molars 102C, 102D, and 102E rotate via forces delivered to the tooth by the pressure plates 134, 136, and 138 and the pressure points 130 and 132 placed gingival to the height of contour on the premolar crowns force the crowns into the aligners to insure extrusion.

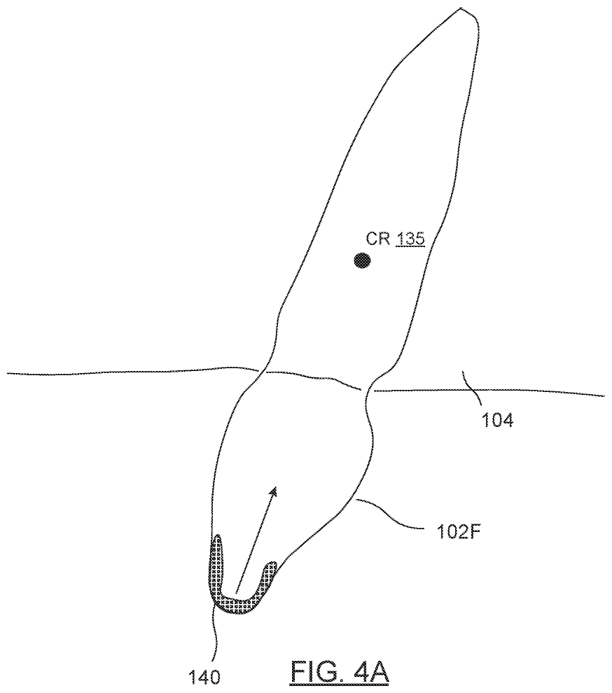

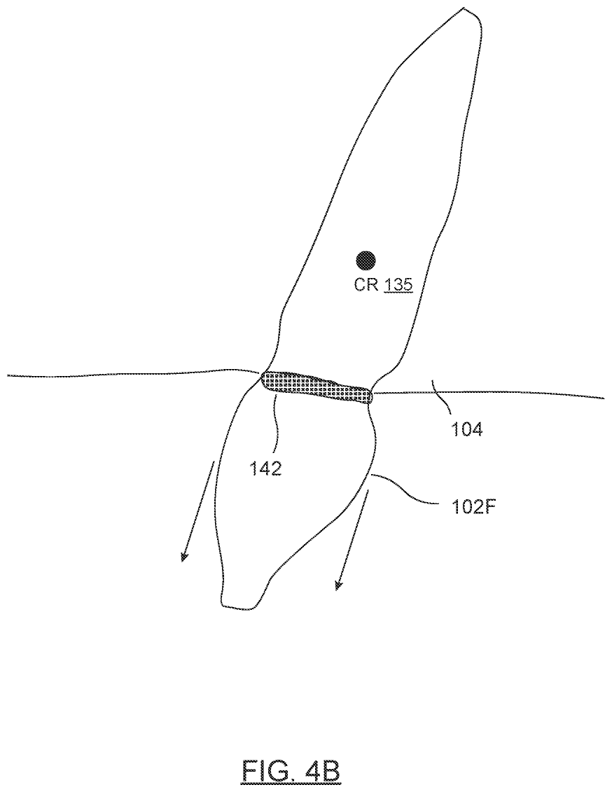

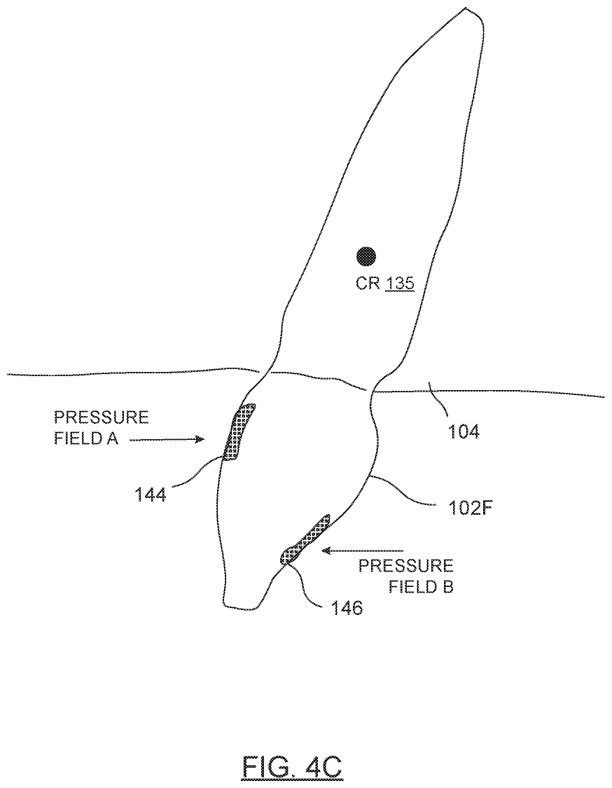

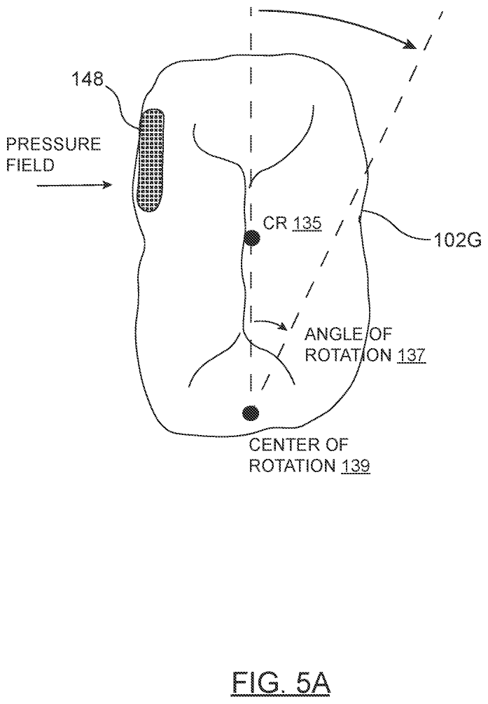

FIG. 4A depicts an example of using orthodontic aligners with a pressure cap to apply an intrusive force to a tooth.

In the intrusion example shown in FIG. 4A, the pressure cap 140 shown causes an intrusive force on the tooth 102F that causes the tooth 102F to move inwardly into the jaw. The center of resistance 135 of the tooth 102F, which is approximately two-thirds of the way down the root of the tooth, is shown in FIG. 4A. For clarity of understanding, a person of ordinary skill will appreciate the pressure cap 140 is not an actual change to tooth 102F but rather indicates the location on the tooth 102F where an inward extrusion in a corresponding orthodontic aligner applies pressure to tooth 102F.

FIG. 4B depicts an example of using orthodontic aligners with a pressure collar to apply an extrusive force to a tooth.

In the extrusion example shown in FIG. 4B, the pressure collar 142 applied by an orthodontic aligner around the neck of the tooth 102F causes an extrusive force on the tooth 102F that causes the tooth 102F to move outwardly away from the jaw. This extrusion example is an example of a situation where a traditional orthodontic aligner 100 would not effectively apply an extrusive force to the tooth without the use of an attachment to the tooth, and even with the use of an attachment to the tooth the movement of the tooth would be unpredictable. However, by creating an inwardly extruding pressure area such as a pressure collar on the inside shell of an orthodontic aligner by digitally or virtually removing a portion of the tooth 102F where shown by pressure collar 142, the extruding pressure area on the orthodontic aligner will apply the extrusive force (as indicated by the arrows in FIG. 4B) at the portion 142 of the tooth 102F.

FIG. 4C depicts an example of using orthodontic aligners with opposing pressure fields to apply a torque to a tooth.

In the torque example shown in FIG. 4C, the application of force at pressure field A 144 and pressure field B 146 on tooth 102F by an orthodontic aligner creates a couple that forms a moment. The size and direction of the moment is equal to the ratio of size and depth of pressure fields A 144 and B 146. Thus, the pressure fields 144 and 146 allow for the control of the application of torque to the tooth 102F relative to the root and crown position around the tooth's center of resistance 135 (designated as “CR” in FIG. 4C).

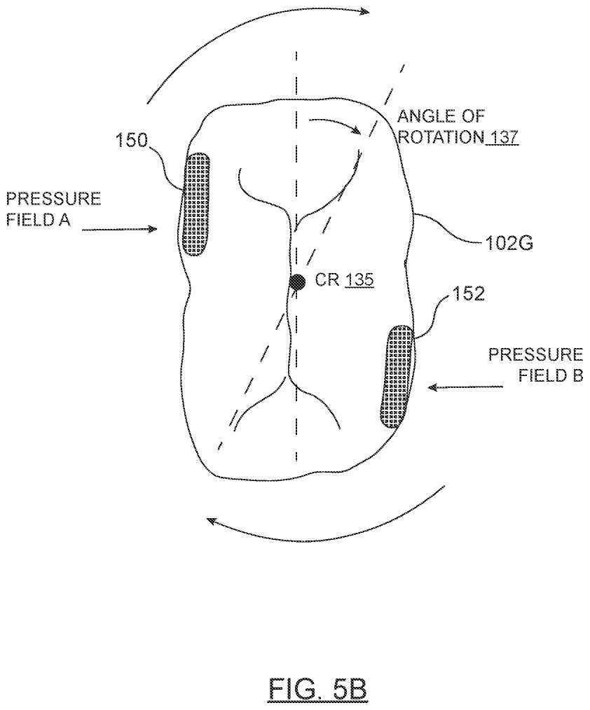

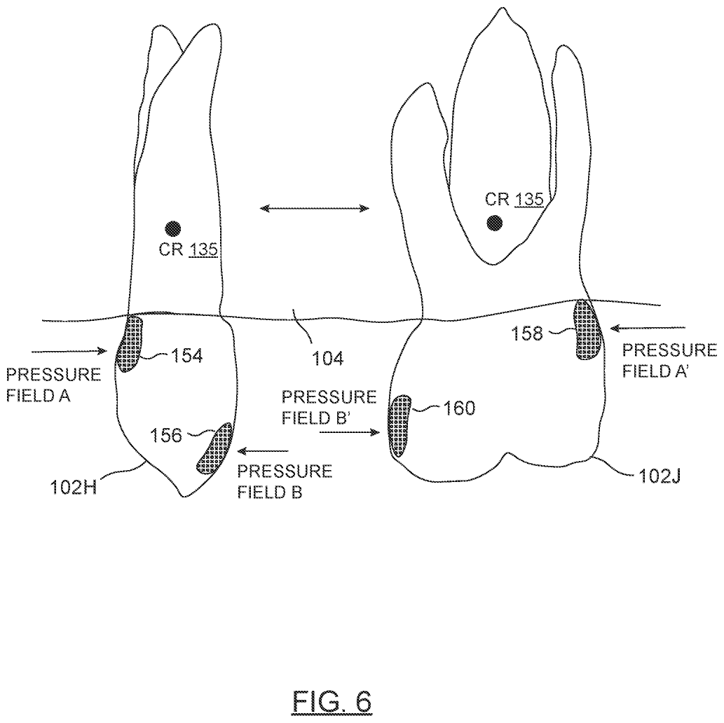

FIG. 5A depicts an example of using orthodontic aligners with a pressure field to apply a hinge torque force to a tooth about a rotational axis of the tooth.

FIG. 5A shows a top-down view of a bottom molar 102G (or, equally, a bottom-up view of a top molar). In the hinge torque example shown in FIG. 5A, the pressure field 148 by an orthodontic aligner causes a rotation of the tooth 102G about an axis or center of rotation 139 that is offset from the center of resistance 135 (designated “CR”) of the tooth 102G. The angle of rotation 137 of the tooth may be measured from the axis or center of rotation, as shown in FIG. 5A.

FIG. 5B depicts an example of using orthodontic aligners with opposing pressure fields to apply a pure torque force to a tooth about the long axis of the tooth.

FIG. 5B shows a top-down view of a bottom molar 102G (or, equally, a bottom-up view of a top molar). In the pure torque example shown in FIG. 5B, the opposing pressure fields A 150 and B 152 by an orthodontic aligner cause a pure rotation of the tooth 102G about the long axis of the tooth 102G, which is approximately the same as the center of resistance 135 (designated “CR”) of the tooth 102G. The angle of rotation 137 of the tooth 102G may be measured from the axis or center of resistance 135, as shown in FIG. 5B.

Thus, the pure torque example of FIG. 5B differs from the hinge torque example of FIG. 5A in that the opposing force provided by pressure field B 152 aligns the center of rotation with the center of resistance.

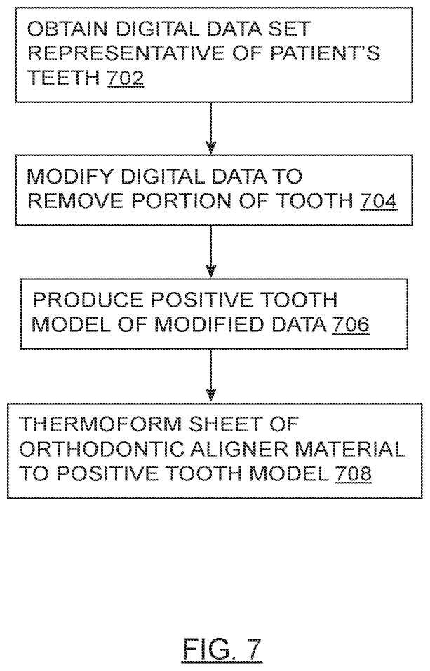

FIG. 6 depicts an example of using orthodontic aligners with one or more pressure fields to apply a bodily translational force to a tooth along the gingival line.

FIG. 6 shows two teeth 102H and 102J with a gap between them. In the bodily translation example shown in FIG. 6, pressure field A 154 and pressure field A′ 158 provide forces at the gingival line 104 to push the two teeth 102H and 102J towards each other. However, if pressure field A 154 and pressure field A′ 158 are the only pressure fields used, then the two teeth 102H and 102J will tip towards one another without the roots moving. Thus, pressure field B 156 and pressure field B′ 160 provide opposing forces against pressure field A 154 and pressure field B 156, respectively, that prevent tipping of the teeth and instead cause a bodily translational movement of the teeth 102H and 102J to move the tooth along the jawline, for example, to close a gap between the two teeth. Adjusting the size of pressure field A 154 and pressure field B 156 relative to each other, as well as pressure field A′ 158 and pressure field B′ 160 relative to each other, results in moments that cause bodily translation of each entire tooth, rather than tipping together of the crowns.

The materials used to fabricate the orthodontic aligners with the inwardly extruding pressure areas disclosed herein may be stiffer for stages of movement that require more force. Similarly, the length of the trim of the orthodontic aligner may vary from the gingival margin to 2 mm above the gingival margin depending on the need for greater force delivery or retention.

FIG. 7 shows an exemplary method for producing an orthodontic aligner for application to teeth of a patient and configured for moving at least one tooth of the patient in accordance with the disclosure herein. Referring to FIG. 7, at block 702, a digital data set representative of the teeth of the patient is obtained. The digital data set includes a virtual tooth that represents a tooth of the patient. As described above, the digital data set may be obtained using an impression kit, and intraoral scanner, or photographs, or any combination thereof.

At step 704, the digital data set representative of the teeth of the patient is modified by digitally removing a portion of tooth structure of the virtual tooth representing at least one tooth of the patient. As explained above, the portion of the tooth structure that is digitally removed is determined by a lab technician, a dentist, an orthodontist, or the like. Computer software is used to digitally or virtually remove the portion of tooth structure of the virtual tooth. The sizes and shapes of the portions that are removed are selected to apply the correct force at the correct location on the tooth, examples of which are shown and described in FIGS. 2-6 above. As explained above, in various embodiments, the depth of the portions that are digitally removed may be up to approximately 0.2 mm in depth (i.e., the inwardly extruding pressure areas in the orthodontic aligner may extrude up to approximately 0.2 mm from the rest of the orthodontic aligner). In some embodiments, where significant moving of the teeth is needed, the depth of the portions that are digitally removed may be larger, up to approximately 0.5 mm in depth.

The amount of digitally or virtually removed tooth is determined based on the surface area of the pressure field or pressure area created by the inward extrusion, with the surface area of the pressure field being the force determinant. In some embodiments, the depth of the inward extrusion begins at an initial fixed value of 0.1 mm, and the size or surface area of the pressure field is varied to apply the desired amount of force. As an example, a pressure field that is 2 mm×1 mm in surface area and extrudes inwardly by 0.1 mm applies twice as much force to a tooth as a pressure field that is 1 mm×1 mm in surface area and extrudes inwardly by 0.1 mm. The initial fixed value of 0.1 mm may be increased as necessary.

At step 706, a positive tooth model is produced based on the modified digital data set representative of the teeth of the patient with the digitally removed portion of tooth structure. As discussed above, the positive tooth model may be produced using 3D printing or additive manufacturing.

At step 708, a sheet of orthodontic aligner material is thermoformed over the positive tooth model to produce the orthodontic aligner with an extruding pressure area associated with the removed portion of tooth structure. The extruding pressure area forms, in the orthodontic aligner, a force-applying component for application of a force to the one tooth.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a,” “an,” and “the” refer to “one or more” when used in the subject specification, including the claims. Thus, for example, reference to “a device” can include a plurality of such devices, and so forth.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for producing an orthodontic aligner for application to teeth of a patient and configured for moving at least one tooth of the patient, the method comprising:
obtaining a digital data set representative of the teeth of the patient, the digital data set including a virtual tooth representing the at least one tooth of the patient;
modifying the digital data set representative of the teeth of the patient by digitally removing a portion of tooth structure of the virtual tooth representing at least one tooth of the patient;
producing a positive tooth model based on the modified digital data set representative of the teeth of the patient with the digitally removed portion of tooth structure; and
thermoforming a sheet over the positive tooth model to produce the orthodontic aligner with an inwardly extruding pressure area associated with the removed portion of tooth structure, wherein the inwardly extruding pressure area forms, in the orthodontic aligner, a force-applying component for application of a force to the at least one tooth.

2. The method of claim 1, wherein the inwardly extruding pressure area is a pressure collar such that the force applied to the at least one tooth by the inwardly extruding pressure area when the orthodontic aligner is engaged with the teeth of the patient is an extrusive force that pulls the at least one tooth away from the jawline.

3. The method of claim 1, wherein the inwardly extruding pressure area is a pressure cap such that the force applied to the at least one tooth by the inwardly extruding pressure area when the orthodontic aligner is engaged with the teeth of the patient is an intrusive force that pushes the at least one tooth into the jawline.

4. The method of claim 1, wherein the force applied to the at least one tooth by the inwardly extruding pressure area when the orthodontic aligner is engaged with the teeth of the patient is a torque force.

5. The method of claim 4, wherein the torque force is an anterior torque that provides anterior rotation of the tooth about the jawline.

6. The method of claim 4, wherein the torque force provides rotation of the tooth about the root of the tooth.

7. The method of claim 4, wherein the torque force provides rotation of the tooth about the long axis of the tooth.

8. The method of claim 4, wherein the torque force is selected from the group of palatal torque, lingual torque, buccal torque, labial torque, and facial torque.

9. The method of claim 8, wherein the torque force is further selected from the group of root torque and crown torque.

10. The method of claim 4, wherein the torque force causes the at least one tooth to rotate around a center of resistance of the at least one tooth.

11. The method of claim 4, wherein the torque force causes the at least one tooth to rotate around a center of rotation of the at least one tooth.

12. The method of claim 4, wherein the torque force causes the at least one tooth to rotate around a point at which the at least one tooth contacts one or more adjacent teeth.

13. The method of claim 1, wherein the force applied to the at least one tooth by the inwardly extruding pressure area when the orthodontic aligner is engaged with the teeth of the patient is a bodily translational force.

14. An orthodontic aligner for application to teeth of a patient and configured for moving at least one tooth of the patient, the orthodontic aligner comprising:
a shell portion having an outer surface and an inner surface, wherein at least a portion of the inner surface is configured to contact the teeth of the patient;
wherein the inner surface includes at least one inwardly extruding pressure area that forms a force-applying component for application of a force to the at least one tooth when the orthodontic aligner is engaged with the teeth of the patient.

15. The orthodontic aligner of claim 14, wherein the inwardly extruding pressure area is a pressure collar such that the force applied to the at least one tooth by the inwardly extruding pressure area when the orthodontic aligner is engaged with the teeth of the patient is an extrusive force that pulls the at least one tooth away from the jawline.

16. The orthodontic aligner of claim 14, wherein the inwardly extruding pressure area is a pressure cap such that the force applied to the at least one tooth by the inwardly extruding pressure area when the orthodontic aligner is engaged with the teeth of the patient is an intrusive force that pushes the at least one tooth into the jawline.

17. The orthodontic aligner of claim 14, wherein the force applied to the at least one tooth by the inwardly extruding pressure area when the orthodontic aligner is engaged with the teeth of the patient is a torque force.

18. The orthodontic aligner of claim 17, wherein the torque force is an anterior torque that provides anterior rotation of the tooth about the jawline.

19. The orthodontic aligner of claim 17, wherein the torque force provides rotation of the tooth about the root of the tooth.

20. The orthodontic aligner of claim 17, wherein the torque force provides rotation of the tooth about the long axis of the tooth.

21. The orthodontic aligner of claim 17, wherein the torque force is selected from the group of palatal torque, lingual torque, buccal torque, labial torque, and facial torque.

22. The orthodontic aligner of claim 21, wherein the torque force is further selected from the group of root torque and crown torque.

23. The orthodontic aligner of claim 17, wherein the torque force causes the at least one tooth to rotate around a center of resistance of the at least one tooth.

24. The orthodontic aligner of claim 17, wherein the torque force causes the at least one tooth to rotate around a center of rotation of the at least one tooth.

25. The orthodontic aligner of claim 17, wherein the torque force causes the at least one tooth to rotate around a point at which the at least one tooth contacts one or more adjacent teeth.

26. The orthodontic aligner of claim 14, wherein the force applied to the at least one tooth by the inwardly extruding pressure area when the orthodontic aligner is engaged with the teeth of the patient is a bodily translational force.
